(19) United States
(12) Patent Application Publication
(10) Pub. No.: US 2025/0060600 A1
(43) Pub. Date: Feb. 20, 2025

(54) ELECTRONIC DEVICE SECUREMENT ARMS

(71) Applicant: Apple Inc., Cupertino, CA (US)

(72) Inventors: Alison B. Shutzberg, San Francisco, CA (US); Paul Williams, Seattle, WA (US)

(21) Appl. No.: 18/440,611

(22) Filed: Feb. 13, 2024

Related U.S. Application Data
(60) Provisional application No. 63/520,174, filed on Aug. 17, 2023.

(51) Int. Cl. G02B 27/01; G02C 5/20

(52) U.S. Cl. CPC G02B 27/0176; G02C 5/20; G02B 2027/0154; G02B 2027/0178

(57) ABSTRACT

The head mountable electronic device can include a display frame and a securement arm extending from the display frame. The securement arm can include a proximal segment including a first contact feature, a distal segment including a second contact feature, the proximal segment disposed between the distal segment and the display frame, and a joint, the distal segment rotatably coupled to the proximal segment at the joint, wherein an interior side of the securement arm defines a interior radius of curvature and an exterior side of the securement arm opposite the interior side defines an exterior radius of curvature, the exterior radius of curvature being greater than the interior radius of curvature.

### CROSS-REFERENCE TO RELATED APPLICATION(S)

This claims priority to U.S. Provisional Patent Application No. 63/520,174 filed 17 Aug. 2023, and entitled “ELECTRONIC DEVICE SECUREMENT ARMS,” the disclosure of which is hereby incorporated by reference in its entirety.

### FIELD

The described embodiments relate generally to electronic devices. More particularly, the present embodiments relate to head mountable electronic devices.

### BACKGROUND

Recent advances in portable computing have enabled head-mountable devices that provide augmented and virtual reality experiences to users. Various component of these devices, such as display screens, viewing frames, securement arms, speakers, batteries, and other components, operate together to provide an immersive and comfortable experience. However, the anatomy of each user's head is unique. One user's head can be larger than another user's head, or one head can be a different shape. Other anatomical features, including relative positions of a user's nose, forehead, and ears, can vary widely between users as well. The anatomical variety of heads presents a challenge for head-mountable devices designed for comfort and reliability.

In some head-mountable devices, for example, securement arms that extend along, or make contact with, opposing sides of a user's head can be used to secure the device to the user's head. However, the dimensions, angles, shape, positions, and other physical characteristics of the arms that can be sufficient to comfortably and reliably secure the device to one user's head may not be sufficient to comfortably and reliably secure the device to another user's head.

Additionally, head-mountable devices can be used in a variety of different settings and during a variety of different activities, as well as in a variety of different orientations. These can range from lying down still in bed to mountain biking or hiking outdoors. Thus, even for a single user, the securement arms of a head-mountable device that are comfortable and sufficient for securing the device during one activity may not be comfortable or sufficient for another activity.

Accordingly, what is needed in the art are head-mountable devices and systems accommodating users having a wide variety of anatomical features and who participate in a wide variety of activities with comfortable and reliable components.

### SUMMARY

In at least one example of the present disclosure, a head mountable device can include a display frame and a securement arm extending from the display frame. The securement arm can include a proximal segment including a first contact feature, a distal segment including a second contact feature, the proximal segment disposed between the distal segment and the display frame, and a joint, the distal segment rotatably coupled to the proximal segment at the joint, wherein an interior side of the securement arm defines a interior radius of curvature and an exterior side of the securement arm opposite the interior side defines an exterior radius of curvature, the exterior radius of curvature being greater than the interior radius of curvature.

In another example of the head mountable device, the proximal segment can include a first proximal end secured to the display frame and a first distal end opposite the first proximal end and the first contact feature can be located at or near the first distal end. In another example of the head mountable electronic device, the distal segment can include a second proximal end secured to the proximal segment at the joint and a second distal end opposite the second proximal end and the second contact feature can be located at or near the second distal end. In another example of the head mountable electronic device, the proximal segment can define a proximal interior radius of curvature, the distal segment can define a distal interior radius of curvature, and the proximal interior radius of curvature can be greater than the distal interior radius of curvature. In another example of the head mountable electronic device, the second contact feature can be oriented towards the display frame. In another example of the head mountable electronic device, the distal segment can be rotatable about the joint to adjust an angle of the second contact feature relative to the display frame.

In at least one example of the present disclosure, a securement arm for a wearable device can include a first portion, an electronic component disposed within the first portion, a proximal portion having a first proximal end rotatably coupled to the first portion and a first distal end opposite the first proximal end, the proximal portion defining a first contact location at or near the first distal end, and a distal portion having a second proximal end rotatably coupled to the proximal portion and a second distal end opposite the second proximal end, the distal portion defining a distal contact location at or near the second distal end, wherein the proximal portion defines an interior side having a concave radius of curvature.

In another example of the securement arm, the distal portion can define a distal interior side and the distal interior side can have a distal radius of curvature aligning with the concave radius of curvature. In another example of the securement arm, a proximal contact distance can be defined between the first contact location and the first portion, and rotating the proximal portion relative to the first portion can cause the proximal contact distance to change. In another example of the securement arm, a distal contact distance can be defined between the distal contact location and the first portion and rotating the distal portion relative to the proximal portion can cause the distal contact distance to change. In another example of the securement arm, rotating the proximal portion relative to the first portion can cause the distal contact distance to change. In another example of the securement arm, the first portion can be configured to rotate outward and inward relative to the proximal portion. In another example of the securement arm, the electronic component can include a projector disposed in the first portion and the first portion can be fixed in position. In another example of the securement arm, the proximal portion can have a first length, the distal portion can have a second length, and the first length can be greater than the second length.

In at least one example of the present disclosure, an electronic device can include a display frame, a securement arm coupled to the display frame, the securement arm including a fixed portion connected to the display frame and including a projector, a first portion coupled to the fixed portion and including a first touch pad at a first contact location, a second portion including a second touch pad at a second contact location, and a joint rotatably coupling the first portion and the second portion, the joint located between the first touch pad and the second touch pad.

In another example of the electronic device, the securement arm can define an interior side oriented toward the display frame and the first touch pad and the second touch pad can extend from the interior side. In another example of the electronic device, the first touch pad can include a first material and the first portion can include a second material different than the first material. In another example of the electronic device, the first material can have a greater coefficient of friction than the second material. In another example of the electronic device, the second touch pad can include surface features configured to increase a friction of the second touch pad against a user when the user dons the electronic device. In another example of the electronic device, the first contact location can be adjacent the joint and the second contact location can be at or near a distal end of the second portion and spaced further from the joint than the first contact location.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a top view of an example of a head mountable device worn by a user;

FIG. 1B shows a rear perspective view of an example of the head mountable device of FIG. 1A;

FIG. 2 shows a top view of an example of a head mountable device worn by a user;

FIG. 3 shows a top view of an example of a head mountable device worn by a user;

FIG. 4 shows a top view of an example of a head mountable device worn by a user;

FIG. 5 shows a top view of various arrangements of an example securement arm of a head mountable device;

FIG. 6A shows a top view of an example securement arm of a head mountable device;

FIG. 6B shows a top view of an example securement arm of a head mountable device;

FIG. 6C shows a top view of an example securement arm of a head mountable device.

### DETAILED DESCRIPTION

Detailed reference will now be made to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to electronic devices. More particularly, the present disclosure relates to head-mountable electronic devices having securement arms. In at least one example, a head-mountable device can include a viewing or display frame and a securement arm extending from the viewing frame. Examples of head-mountable electronic devices can include virtual reality or augmented reality devices that include an optical component. In the case of augmented reality devices, optical eyeglasses or frames can be worn on the head of a user such that optical lenses. Optical displays can be positioned in front of the user's eyes. In another example, a virtual reality device can be worn on the head of a user such that a display screen is positioned in front of the user's eyes. The viewing frame can include a housing or other structural components supporting or housing the optical component, for example lenses or screens, or various electronic components.

Head-mountable electronic devices, such as head-mountable optical devices delivering virtual and augmented reality experiences, can be used in a variety of different settings and during a variety of activities. For example, a user can lie down on a sofa or a bed while watching a movie or playing a game with a head-mountable virtual reality device. That same device, or some other augmented reality device, such as electronic glasses, can be used while exercising indoors on an exercise machine. Similarly, devices like augmented reality glasses can be used while being active outdoors, either while hiking, biking, or swimming. The devices of the present disclosure include components, such as securement arms, which can be adapted to comfortably secure head-mountable devices to the user during the various activities in which the user participates.

In addition, the head measurements and anatomical features of each user can vary such that a securement arm of the same fixed length or shape and orientation may not be appropriate for every user. For example, some heads are rounder than others. Some heads are larger or smaller and the position of a user's nose relative to their eyes can vary. The position of a user's cars relative to their nose or forehead can vary from one user to another such that an arrangement of securement arms that effectively secure a head-mountable device to one user do not effectively secure the same device to another user. Further, some regions of the head are not suitable for supporting the optical device. For example, a user's temples can be sensitive to prolonged pressure or contact.

In addition, manufacturing individualized display frames or arms for each unique customer can be burdensome and often economically unfeasible. The head-mountable electronic devices of the present disclosure include securement arms and components that can be altered and customized to each user and for each activity. The same user can adjust the securement arms of a device, for example, to contact at specific locations or regions of the user's head or to avoid contact with sensitive regions. The securement arms can also adjust to apply pressure more tightly or wrap further around the user's head when using the head-mountable device for exercise or other active scenarios. The same user can readjust the securement arms for a more comfortable fit while using the head-mountable device for less active scenarios, including lying down, sitting, or walking. In addition, some head-mountable devices can be used by multiple people, including multiple people in a household or business office, with each person having a different head geometry. Securement arms for devices described herein can be customized for the same device to be comfortably and effectively used by each of the multiple individuals using the device.

The optical electronic device can include one or more electronic components used to operate the head-mountable electronic device. These components can include any components used by the head-mountable electronic device to produce a virtual or augmented reality experience. For example, electronic components can include one or more projectors, speakers, processors, batteries, circuitry components including wires and circuit boards, or any other electronic components used in the head-mountable device to deliver augmented or virtual reality visuals, sounds, and other outputs. The various electronic components can be disposed within the housing of the display frame or within the securement arm. The various electronic components can be distributed in both the display frame and/or the securement arms to disperse or redistribute weight throughout the optical electronic device. The various electronic components can result in an optical electronic device having a comparatively greater weight than traditional glasses or eyewear. To create a more comfortable experience, the contact locations or weight of the securement arms or display frame can be arranged or defined to comfortably distribute the weight or pressure of the optical device on a user's head. This redistributed weight can relieve weight from sensitive features like the user's nose or cheeks relieve or avoid contact with sensitive features like the user's temple to create a more comfortable experience. The contact locations and weight distribution can also be used to balance weight from the front of the device (e.g. from the viewing frame) to the back of the device, such as at the distal ends of the securement arms or portions of the securement arms, resulting in a more secure and comfortable experience.

Examples of the present disclosure can include a securement arm extending from the viewing frame. The securement arm, or a portion of the securement arm, can be fixed in position relative to the viewing frame or rotatably secured thereto. An optical electronic device can include two opposing securement arms that can adjustably contact or apply pressure to or around a user's head to maintain the viewing frame resting on the user's nose and/or cheeks. In some examples, the securement arms can rest on top of the user's ears to assist in securing the head-mountable optical device to the head of the user.

The securement arm can include multiple portions. The multiple portions can be arranged to define contact locations at various areas of a user's head to maintain comfortable contact or pressure. For example, each securement arm can contact or apply pressure to the user's head in at least two locations to distribute the weight of the optical device. The securement arms can contact the user's head distal to, or to the rear of, the temple and at or adjacent the car at a first contact location. The first contact location can avoid unconformable contact between the securement arm and the temple. The securement arms can contact the user at the rear or back of the head and distal to the user's cars at a second contact location, which can be a region of the user's head less sensitive to pressure. Additionally, supporting the device at the rear of the user's head can constrain or limit the optical device from moving forward off the user's face. The securement arm portions can be adjustable to accommodate various differences in head shape or anatomical features between users and/or position the contact locations at a comfortable region for each users' head.

In examples where the securement arm includes multiple portions, a first or proximal segment can rotatably couple to the display frame or to a first portion of the securement arm extending from the display frame. The first portion may be rigidly connected to or extending from the display frame. The proximal segment can be rotatably coupled to a second or distal segment at a joint. The distal segment can rotate relative to the first portion to adjust the angle or position of the distal segment relative to the proximal segment or the display frame. For example, the distal segment can rotate axially around a longitudinal axis defined by the joint. The segments can be arranged such that the proximal segment contacts the user's head at the first contact location and the distal segment contacts the user's head at the second contact location.

The securement arms of the present disclosure can define an interior radius of curvature and an exterior radius of curvature. The interior radius of curvature can be defined by the interior side or sides of the securement arms. The interior radius of curvature can be concave relative to the head of a user. The exterior radius of curvature can be defined by the exterior side or sides of the securement arm. The interior radius of curvature can be less than the exterior radius of curvature. The interior radius of curvature can space the securement arms from the user's temple to prevent or limit uncomfortable contact or pressure at the temples. For example, the interior radius of curvature can space the proximal portion from the temples whether the proximal portion is rotated inward or outward relative to the display frame. The curvature can also align the securement arms at the contact locations to comfortably contact the user's head. The second or distal portion can be shaped such that when the distal portion is rotated, the distal portion can adjustably change angles or curvature relative to the proximal portion. In this way, the overall curvature of the securement arm can be adjusted and customized to each user or for a single user participating in different activities.

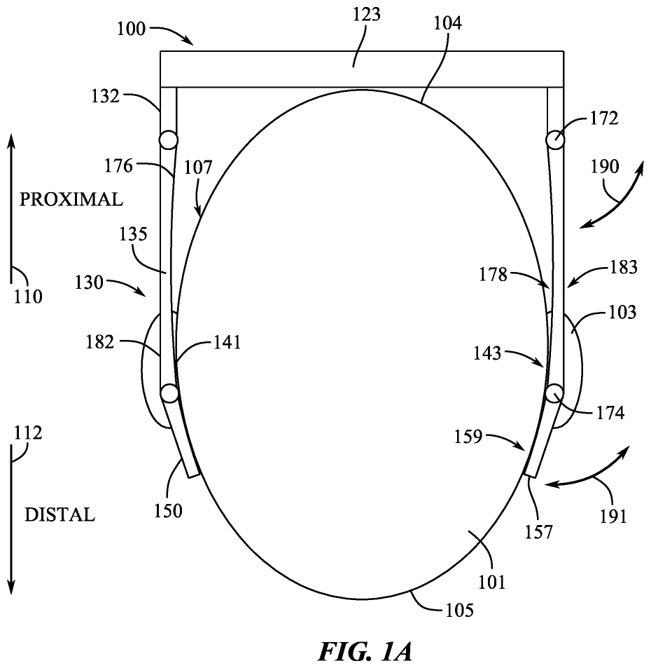

These and other embodiments are discussed below with reference to FIGS. 1-6C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A illustrates a top view of an example wearable device, for example a head mountable electronic device 100, worn on a head 101 of a user. In one example, the head mountable electronic device 100 can be an optical device. The optical device 100 can include a display frame 123 configured to position one or more windows, for example optically transparent lenses or display screens 125 (shown in FIG. 1B), in front of the eyes or face of the user. The optically transparent window allows at least some visible light to pass from one side of the window to the other side, allowing a user to see objects through the window. The optical device 100 can also include one or more securement arms 130 connected or attached to the display frame 123 and extending distally toward the rear 105 of the user's head 101. The securement arms 130 can each contact the user's head 101 at two or more contact locations. For example, the securement arms 130 can contact the user's head 101 at a first contact location 143. The first contact location 143 can be a region on the user's head 101 in a distal direction 112 relative to the user's temple 107 and at or adjacent the user's ear 103. The securement arms 130 can contact the user's head 101 at a second contact location 159. The second contact location 159 can be a region in a distal direction 112 relative to the user's ear 103, such as at or adjacent the back 105 of the user's head 101.

With reference to FIG. 1B, illustrating a rear perspective view of an example of the head mountable electronic device 100, the viewing or display frame 123 can include one or more lenses or display screens 125 positioned in a housing 128. The windows, for example the optically transparent lenses or display screens 125, can be positioned in front of a user's eyes or otherwise on the front 104 of a user's head 101. The display screens 125 can be configured to produce or provide a virtual or augmented reality experience. The optical device 100 can include electronic components to produce a virtual or augmented reality experience, or otherwise generate images on the display screen or lenses. For example, the electronic components can include one or more projectors, screens, lighting devices, speakers, processors, batteries, circuitry components including wires and circuit boards, or any other electronic components used in the head-mountable device 100 to deliver augmented or virtual reality visuals, sounds, and other outputs. In some examples, the various electronic components can be disposed within the display frame 123, such as in the housing 128 or the display screens or lenses 125. In some examples, the various electronic components can also be distributed in both the display frame 123 and/or the securement arms 130 to disperse or redistribute weight throughout the optical electronic device 100.

Returning to FIG. 1A, the securement arms 130 can rotatably couple to or extend from the display frame 123 in the distal direction 112. The distal direction 112 can be the direction towards the rear 105 of the user's head 101 relative to the front 104. The proximal direction 110 can be opposite the distal direction 112, such as the direction towards the front 104 of the user's head 101 relative the rear 105.

The securement arms 130 can optionally include a first portion 132 attached to or extending from the display frame 123 in the distal direction 112. The first portion 132 can be fixed or rigidly connected to the display frame 123 (e.g., a fixed portion 132). Accordingly, in some examples the first portion 132 can be referred to as a component of the display frame 123 or as the fixed portion 132. In some examples, the first portion 132 can define an internal volume and can include or house one or more of the various electronic components.

The securement arms 130 can include a proximal segment or portion 135 rotatably coupled to the first portion 132. In some examples, the proximal segment 135 can rotatably connect or couple to the display frame 123. The proximal segment 135 can be rotatably coupled by or to a first joint 172. The proximal segment 135 can extend in the distal direction 112 relative to the first portion 132. The proximal segment 135 can be an elongated feature. The proximal segment 135 can be sized to extend past the temple 107 to a location at or near the car 103, defining the first contact location 143. The first contact location 143 can be located at or adjacent a distal end 141 of the proximal segment 135. In some examples, the proximal segment 135 can include or define contact features at the first contact location 143 to increase the grip or support of the securement arms 130. In one example, the contact features described herein can include raised features. In one example, contact features can include grooves. In one example, contact features can include pads. The contact features described herein can be positioned on or with the securement arms 130 and configured to make contact with the user's head when donning the optical device 100.

The securement arms 130 can include a distal segment 150 rotatably connected or coupled to the proximal segment 135. For example, the proximal segment 135 can be disposed between the first portion 132 and the distal segment 150. The distal segment 150 can extend in the distal direction 112 from the proximal segment 135, terminating at a distal end 157. The distal segment 150 can be an elongated feature. The distal segment 150 can be comparatively shorter in length than the proximal segment 135. The distal segment 150 can also extend rotatably or adjustably inward (e.g., towards or along the user's head 101) relative to the proximal segment 135. In some examples, the distal segment 150, as shown in FIG. 1B, can extend downward relative to the proximal segment 135. The distal segment 135 relative can extend from the proximal segment 135 to a location distal to the car 103 and at or along the rear 105 of the user's head 101, defining the second contact location 145. The second contact location 159 can be located at or adjacent a distal end 157 of the distal segment 150. In some examples, the distal segment 150 can include or define contact features (e.g. raised features, grooves, and pads) at the second contact location 159 to increase the grip or support of the securement arms 130.

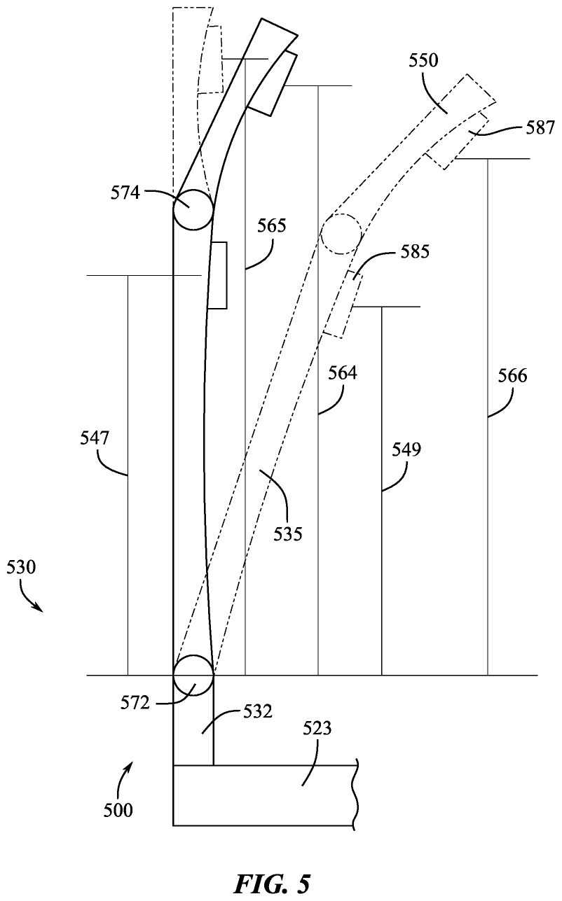

With reference to FIG. 1A and FIG. 1B, the proximal segment 135 can couple to the first portion 132 or the display frame 123 at a first joint 172. The proximal segment 135 can rotate about the first joint 172. For example, the proximal segment 135 can rotate horizontally about a first longitudinal axis 116 defined by the first joint 172, as indicated by arrow 190. The horizontal rotation 190 can assist in adjusting the fit of the optical device 100 to accommodate various head shapes or hairstyles. For example, the rotation of the proximal segment 135 relative to the display frame 123 or first portion 132, can adjust the position of the first contact location 143 relative to the user's head 101. In some examples, the rotation of the proximal segment 135 about the joint 172 can facilitate the adjustment of the second contact location 159 of the distal segment 150 on the user's head 101, as discussed in greater detail below with reference to FIG. 5.

In some examples, the proximal segment 135 can vertically rotate about the joint 172 or vertically relative to the display frame 123. For example, the proximal segment 135 can rotate vertically about a first latitudinal axis 115, as indicated by arrow 192. The vertical rotation 192 can accommodate various sizes of ears or positions of ears 103 relative to a user's face 104 or nose by vertically adjust the first contact location 143 or the second contact location 159.

The distal segment 150 can rotatably couple to the proximal segment 135 at a second joint 174. The distal segment 150 can rotate relative to the proximal segment 135 about the second joint 174. For example, the distal segment 150 can rotate horizontally about a second longitudinal axis 117 defined by the second joint 174, as indicated by arrow 191. The horizontal rotation 191 can accommodate various head shapes or hairstyles. For example, the joint 174 can facilitate the adjustment of the second contact location 159 of the distal segment 150 on the user's head 101. The first contact location 143 can be located adjacent the joint 174. The second contact location 159 can be spaced further from the joint 174 than the first contact location 143. For example, the second contact location can be spaced from the joint 174, such as at or near the distal end 157 of the distal segment 150. In some examples, the proximal segment 135 can rotate vertically about a latitudinal axis 119, as indicated by arrow 192. The vertical rotation 192 can accommodate various sizes of cars or positions of cars 103 relative to the rear 105 user's head 101, or various shapes and sizes of heads 101 generally.

Returning to FIG. 1A, the securement arm 130 can have an interior or interior oriented side 176 and an exterior or exterior oriented side 182 opposite the interior side 176. In one example, the interior side 176 can include a side or surface of the securement arm 130 adjacent to or facing inward toward the head of a user when the optical device 100 is donned as shown. In one example, the interior side 176 can include a side or surface of the securement arm closest to or facing the display frame 123. In one example, the exterior side 182 of the securement arm 130 can include a side or surface of the securement arm 130 opposite the interior side 176. The exterior side 182 can include a side or surface of the securement arm 130 facing outward or away from the head of the user when donning the optical device 100. In one example, the exterior side 182 of the securement arm 130 can include a side or surface of the securement arm 130 further away from or facing away from (relative to the interior side 175) the display frame 123. The interior side 176 can define an interior radius of curvature 178. The interior radius of curvature 178 can be concave or arc around a portion of the user's head 101. In some examples, the interior radius of curvature 178 can be defined by the radius of an arc intersecting the first joint 172, the second joint 174, and a portion of the distal segment 150, such as the second contact location 159 or the distal end 157 of the distal segment 150.

An exterior radius of curvature 183 can be defined by the exterior side 182 of the engagement arm 130. The exterior radius of curvature 183 can be different from the interior radius of curvature 178. In one example, the exterior radius of curvature 183 can be greater than the interior radius of curvature 178. In some examples, the exterior side 182 can be flat (e.g., mathematically infinite exterior radius of curvature 183). The different radii can allow the interior radius 178 to be selected for improving fit or comfort of the securement arms 130, while the exterior radius 183 can be selected for an aesthetic appearance or a separate functionality.

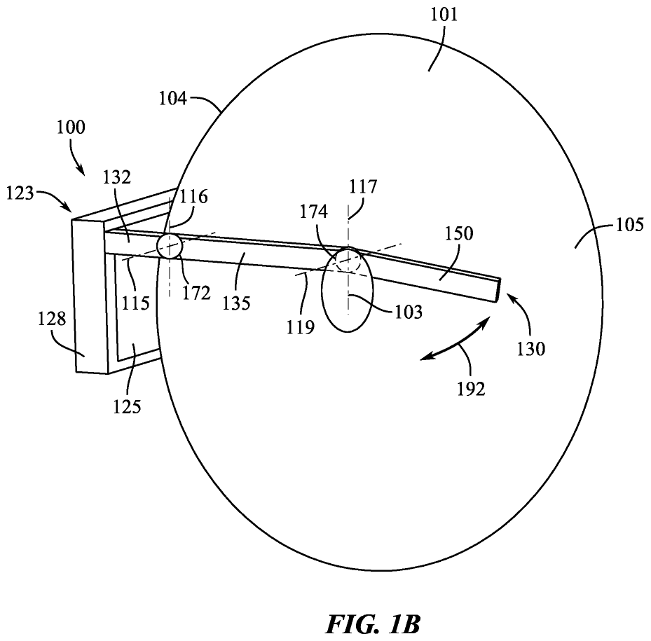

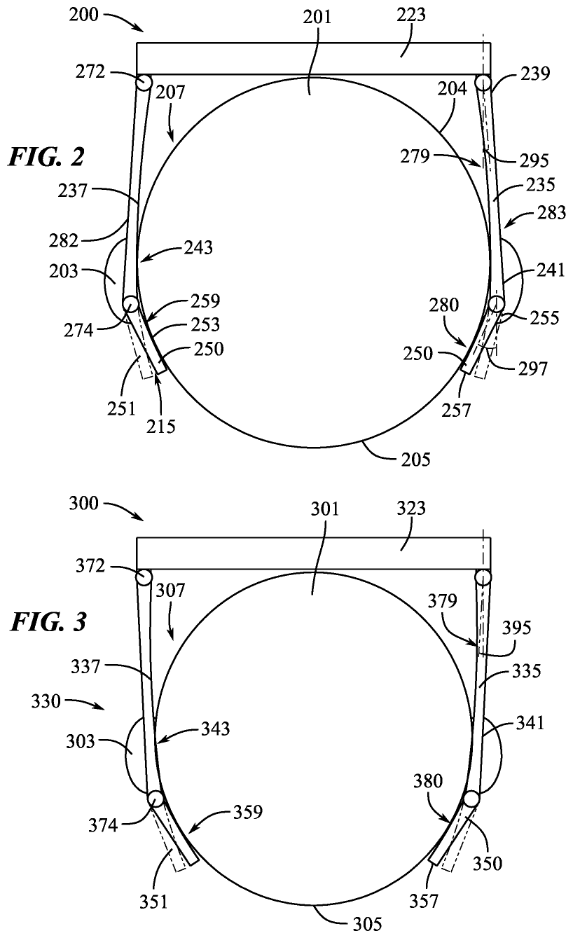

The interior radius of curvature 178 can space or distance the proximal segment 135 from the user's temple 107. For example, the proximal segment 135 can extend between the first joint 172 and the first contact location 143 and be spaced from or extend around a user's temple 107 because of the interior radius of curvature 179. The interior radius of curvature 178 can facilitate positioning the first contact location 143 at or adjacent the user's ear 103 and distal to the temple 107. As can be shown and as discussed below with reference to FIG. 2 and FIG. 3, the interior radius of curvature 179 can prevent or reduce the contact with the temple 107 for heads 101 that are wider or narrower than the display frame 123, or for heads 101 that are shorter or longer.

The interior radius of curvature 178 can also facilitate the positioning of the distal segment 150 such that the second contact location 159 is distal to the car 103. For example, the distal segment 150 can extend inward relative to the ear 103 to contact the rear 105 of the user's head 101, which can be a relatively comfortable location on the head 101 to support the device 100. The interior radius of curvature 178 can assist in aligning the proximal segment 135 and the distal segment 150 to extend behind the car 103.

The interior radius of curvature 178 can facilitate the positioning the contact locations at the distal ends of the proximal segment 135 (e.g., first contact location 143) or the distal segment 150 (e.g., second contact location 159). For example, the first contact location 143 can be at or adjacent the distal end 141 of the proximal segment 135. The second contact location 159 can be at or adjacent the distal end 157 of the distal segment 150. By positing the contact locations 143, 159 at the distal ends of the segments, the forces imparted on the head 101 of the user necessary to balance or support the optical device 100 can be more evenly distributed between the securement arms 130 and the display frame 123. In some examples, the forces at an individual location can be reduced. For example, contact locations at the distal ends 141, 157 of the segments relative to the display frame 123 can produce a larger moment relative to the display frame 123 with lesser force. The larger moment can facilitate distribution of the weight of the optical device 100 across the contact locations 143, 157 and the user's nose or cheeks, as opposed to larger concentrated loads at any of the locations.

Any of the features, components, and/or parts, including the arrangements and configurations thereof shown in FIG. 1A or FIG. 1B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1A or FIG. 1B.

FIG. 2 illustrates a top view of an example of a head mountable device 200. The head mountable device 200 can be positioned on the head 201 of a user. The user's head 201 can be comparatively wider than the user's head 101, as shown in FIG. 1A and with reference to the head mountable device 100. Accordingly, FIG. 2 can show an example of the head mountable device 200 adjustably positioned to fit a user with a wider head 201.

The head mountable device 200 can include similar or the same features of the head mountable device 100. For example, the head mountable device can be an optical device 200. The head mountable device 200 can include a display frame 223 and securement arms 230. The securement arms 230 can couple to or extend from the display frame 223. The securement arms 230 can include a proximal portion or segment 235 and a distal portion or segment 250. In contrast to FIG. 1, the head mountable device 200 the proximal segment 235 can rotatably connect or secure to the display frame 223 rather than a first portion 132. Accordingly, the proximal segment 235 can be, or referred to as, the first segment or the first portion 235. The distal segment 250 can be, or referred to as, the second segment or the second portion 250.

The first segment 235 can rotatably connect to the display frame 223 at a first joint 272. The first segment 235 can include a first proximal end 239. The proximal end 239 of the first segment 235 can be coupled to the first joint 272. The first segment 235 can be an elongated feature extending distally from the first joint 272 to a first distal end 241 of the first segment 235, the distal end 241 opposite the proximal end 239. The first segment 235 can extend from the first joint 272 to a location distal to the user's temple 207 defining a first contact location 243. The first segment 235 can extend to a location at or adjacent the user's ear 203.

The distal or second segment 250 can rotatably connect or couple to the first segment 235 at a second joint 274. The second segment 250 can be an elongated feature extending distally from the second joint 274. The second segment 250 can include a second proximal end 255 and the proximal end 255 can be connected to the second joint 274. The second segment 250 can include or define a second distal end 257 opposite the proximal end 255, the distal end 257 defining at a second contact location 259. The second segment 250 can extend distally from the second joint 274 to a location distal to the car 203 and at or along the rear 205 of the user's head 201.

The first segment 235 can have a proximal interior or proximal interior oriented side 237. The proximal interior side 237 can define or have a proximal radius of curvature 279. The second segment 250 can define include a distal interior or distal interior oriented side 253. The distal interior side 253 can define or have a distal interior radius of curvature 280. The proximal radius of curvature 279 and the distal radius of curvature 280 can be concave. In some examples, the proximal interior radius of curvature 279 can be the same, less than, or greater than the distal interior radius of curvature 280. The proximal radius of curvature 280 and the distal interior radius of curvature 280 can align. For example, the proximal radius of curvature 279 and the distal radius of curvature 280 can be the same, or the proximal radius of curvature 278 at the proximal distal end 241 can be similar to the distal radius of curvature 280 at the distal proximal end 255 to create the appearance of a continuous curvature. As discussed above, the interior radii of curvature can allow the securement arm 130 to extend to the contact locations without contacting sensitive areas on the head 201. For example, the first segment 230 can contact the user's head 201 at the first contact location 243 in a region distal to the temple 207 and at or adjacent the ear 203. The second segment 250 can contact the user's head 201 at a second contact location 259 distal to the car 203.

The first segment 235 and second segment 250 can have or define an exterior or exterior oriented side 282 opposite the interior sides 237, 253. The exterior side 238 can define or have an exterior radius of curvature 283. The exterior radius of curvature 283 can be greater than the proximal interior radius of curvature 279. The exterior radius of curvature 283 can be greater than the distal interior radius of curvature 280. In some examples, the exterior radius of curvature 283 can be greater than the proximal interior radius of curvature 279 and the distal interior radius of curvature 280.

With continued reference to FIG. 2, the securement arms 130 can be adjustable relative to the display frame 223 to accommodate various head sizes or shapes or hairstyles. For example, the first segment 230 can rotate about the first joint 272 to accommodate various head widths. The first segment 230 can rotate outward or inward relative to the display frame 223. The orientation of the first segment 235 relative to the display frame 223 can define a proximal splay angle 295. As shown in FIG. 2, the first segment 235 can rotate outward, defining a positive proximal splay angle 295. A positive proximal splay angle 295 can accommodate a head 201 having a width similar or greater than a width of the display frame 223. Additionally, the proximal interior radius of curvature 279 can accommodate a wider head 201 in comparison to the head 101 illustrated in FIG. 1, by allowing the first segment to curve around or extend in a spaced manner from the temple 207. The proximal interior radius of curvature 279 can also reduce the proximal splay angle 295 for a wider head 201, which can be an aesthetically preferential fit of the optical device.

The second segment 250 can rotate about the second joint 274 to accommodate various head shapes, sizes, or hairstyles. The angle of the second segment 250 relative to the display frame 223 can define a distal splay angle 297. The distal splay angle 297 can position the distal interior side 253 of the second segment 250 or the second contact location 259 facing towards the display frame 223. As shown, the second segment 250 can rotate about the second joint 274 define a negative distal splay angle 297. The adjustable rotation of the second segment 250 can allow a user to set the second segment 250 at a position unique to their head 201. For example, the user can rotate the distal segment 250 from an initial position 251 to contact the rear 205 of the user's head 201 at the second contact location 259.

Additionally, proximal interior radius of curvature 279 of the first segment 235 can assist in positioning the second segment 250 or reducing the size or degree of the distal splay angle 297. For example, absent the proximal interior radius of curvature 279, the distal end 241 of the first segment 235 could be comparatively further from the user's head 201, defining a comparatively larger gap 215. Accordingly, the second segment 250 would require a larger distal splay angle 297 to contact the user's head 201. A larger distal splay angle 250 can result in the second contact location 259 contacting the user at a location closer to the car 203. Positioning the second contact location 259 closer to the car 203 can concentrate the weight of the optical device around the car 303 or otherwise be less comfortable than a location distal to the car 303.

The adjustable rotation can assist the user in fitting or putting on the optical device 200. For example, the user can don the optical device 200 with the second segment 250 in the initial position 251. In the initial position 251, a gap 215 can be defined between the user's head 201 and the second segment 250. With the second segment 250 in the initial position 251, the user can position the optical device 200 with the display frame 223 in a viewing position or comfortable position on or relative to the user's face 204. The user can also position the first segments 230 with the first contact location 243 in a comfortable position to the rear of the temple 207. The user can then adjustably rotate the second segment 250 to contact the rear 205 of the user's head 201 at the second contact location 259. After adjustment, the gap 215 can be reduced or eliminated and the weight of the optical device 200 can be supported, in part, at the second contact location 259. Accordingly, the second segment 250 can secure the optical device 200 in a desired position, such as limiting movement of the display frame 223 in the proximal direction 110 of FIG. 1.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

FIG. 3 illustrates a top view of an example of a head mountable device 300. The user's head 301 shown in FIG. 3 can be comparatively shorter or narrower than the user's head 201, as shown in FIG. 2 and with reference to the head mountable device 200. Accordingly, FIG. 3 can show an example of the head mountable device 300 adjustably fitted to a user with a shorter or narrower head 301.

The head mountable device 300 can be similar or the same as the head mountable device 200 of FIG. 2 and can include one or more of the same or similar features. For example, the head mountable device 300 can include a securement arms 330 rotatably connected to a display frame 323 and extending distally from the display frame 323. The securement arm 330 can include a proximal or first segment 335 and a distal or second segment 350. The first segment 335 can define a first contact location 343 at a distal end 341 of the first segment 335. The second segment 350 can define a second contact location 359 at a distal end 357 of the second segment 350. The first segment 335 can be rotated relative to the display frame 323 about a first joint 372. The second segment 350 can be oriented relative to the display frame 323 by rotating first segment 335 about the first joint 372 or by rotating about a second joint 374 between first segment 335 and the second segment 350. For example, the securement arms 330 can be adjusted to position the first contact location 343 at a region distal to the temple 307 and at or adjacent the ear 303. The securement arms 330 can be adjusted to position the second contact location 359 distal to the ear 303, such as at the back or rear 305 of the user's head 301. The first segment 335 can have or define an interior side 337 defining an interior radius of curvature 379.

To accommodate a narrower head 301, the securement arms 330 can rotate relative to the display frame 323 of the head mountable device 300. For example, the first segment 335 can rotate about the first joint 372. The position of the first segment 335 relative to the display frame 323 can define a proximal splay angle 395. To accommodate a comparatively narrower head 301, the first segment 235 can rotate inwardly to define a less positive or negative proximal splay angle 395 in comparison to the proximal splay angle 295 of FIG. 2. As similarly discussed above, the second segment 350 can rotate about the second joint 374 from an initial position 351 to contact the head 301 at the second contact location 359. The adjustability of the position of the first segment 335 by the first joint 372 allows the securement arms 330 to maintain a comfortable fit on the narrower head 301. The interior radius of curvature 379 can also assist in arranging the securement arms 330 to a comfortable fitting position. For example, the interior radius of curvature 379 can space the interior side 337 of the first segment 335 from the temple 307.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

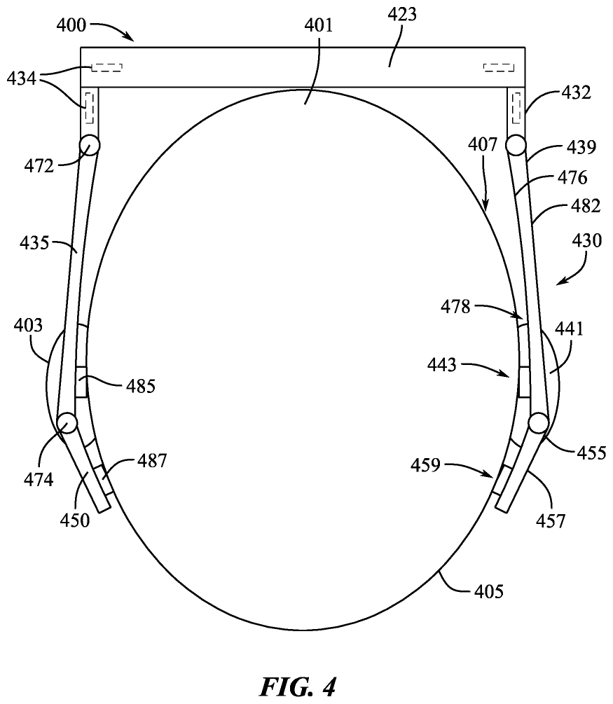

FIG. 4 illustrates a top view of an example head mountable device 400 on a user head 401. The head mountable device 400 can be an optical electronic device or electronic glasses. The optical electronic device 400 can provide virtual and augmented reality experiences, can be used in a variety of different settings and during a variety of activities. For example, the optical electronic device 400 can display visual media images, video, or other graphics for viewing by the user. The optical electronic device 400 can include various electronic components 434 for displaying the visual media, various audio media, or for other various functions of the optical electronic device 400. For example, the electronic components 434 can include one or more, projectors including waveguides, screens, lighting devices, speakers, processors, batteries, circuitry components including wires and circuit boards, or any other electronic components used in the head-mountable device 100 to deliver augmented or virtual reality visuals, sounds, and other outputs. The optical electronic device 400 can be worn indoors while the user is upright or laying down, or the optical electronic device 400 can be worn during activities where the user is moving or outdoors.

The optical electronic device 400 can include a display frame 423. The optical electronic device 400 can include securement arms 430 extending from, or coupled to, the display frame 423. The securement arms 430 can secure the optical electronic device 400 to the head 401 of the user. The securement arms 430 can include a first or fixed portion 432 coupled to or extending distally from the display frame 423. The fixed portion 432 can be rigidly connected or fixed to the display frame 423. The securement arms 430 can include a proximal segment or portion 435. The proximal portion 435 can be rotatably connected to the fixed portion 432. For example, a first joint 472 can rotatably secure a proximal end 439 of the proximal portion 435 to the fixed portion 432. The securement arms 430 can include a distal segment or portion 450. The distal portion 450 can be rotatably connected to the proximal portion 435. For example, a second joint 474 can rotatably secure a proximal end 455 of the distal portion 450 to a distal end 441 of the proximal portion 435, the distal end 441 opposite the proximal end 439.

The various electronic components 434 can be housed in or attached to the either or both of the display frame 423 or the securement arm 430. In some examples, the fixed portion 432 can include the various electronic components 434 to reduce a concentration of the electronic components, such as to allow for cooling or disperse weight. Some of the electronic components 434, such as a speaker, light, waveguide, or projector oriented at the display frame 423 and configured to project light that is displayed at the window secured to the display frame 423, can require a fixed position of the fixed portion 432 relative to the display frame 423. Accordingly, the fixed portion 432 can define a volume that allows the securement arms 130 to house electronic components 434 while remaining adjustable for various head sizes.

The securement arms 430 can define or contact the head at a first contact location 443 and a second contact location 459. The first contact location 443 can be defined by the proximal portion 435 at or adjacent the distal end 441 of the proximal portion 435. The first contact location 443 can contact the head 401 at a location distal to the temple 407 and at or adjacent the cars 403. The second contact location 459 can be defined at or adjacent the distal end 457 of the distal portion 450. The second contact location 459 can contact the user's head 401 at a location behind or distal to the ear 403, such as along the rear or back 405 of the head. The securement arms 430 can have an interior or interior oriented side 476 and an exterior or exterior oriented side 482 opposite the interior side 476. The interior side 176 can define a concave interior radius of curvature 478. The interior radius of curvature 478 can increase the comfort of the securement arms 430 by spacing the proximal portion from the temples 407 of the user.

The securement arms 430 can include contact features 485, 487 at the contact locations. For example, the proximal portion 435 can include a first contact feature 485 at the first contact location 443. The distal portion 450 can include a second contact feature 487 at the second contact location 459. The contact features 485, 487 can be located and configured to make contact with the user's head 401 when donning the electronic device 400. The contact features 485, 487 can be sections defined by or attached to the securement arms 430 to assist in securing the optical electronic device 400 to the head 401 of the user. The contact features 485, 487 can be proud or raised above the interior side 476 of the securement arms 430. The contact features 485, 487 can be oriented inward or facing towards the display frame. For example, the second contact feature 487 can extend from the interior side 476 in an orientation facing towards or at an angle relative to the display frame 423.

The material of the contact features 485, 487 can be the same as the securement arms 430 or different. For example, the contact features 485, 487 include a contact material, where the contact material is different from an arm material of the securement arms 430. The contact material can be one or more of a rubber, a polymer, or a silicon-based material. The contact features 485, 487 can be elastically deformable or otherwise provide padding to increase user comfort. In one example, the contact features 485, 487 can be touch pads, coatings, or similar features.

The contact features 485, 487 can increase or have a greater coefficient of friction compared to the rest of the engagement arms 430. The increased coefficient of friction can assist in preventing movement of the optical electronic device 400 relative to the head 401 of the user, such as during outdoor activities. The contact features 485, 487 or touch pads can also define a larger surface area to disperse force at the contact locations 443, 459. A greater dispersion of forces can be more comfortable to a user.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 illustrates a partial top view of orientations of an example head mountable electronic device 500. FIG. 5 demonstrates how the rotation of the portions of the securement arm 530 relative to the display frame 523 can assist in fitting the securement arms 530 to user heads of different sizes of shapes. The head mountable electronic device 500 can include a display frame 523 and one or more securement arms 530. The securement arms 530 can include a first portion 532 extending from the display frame 523. A proximal portion 535 can rotatably couple to the first portion 532 at a first joint 572. A distal portion 550 can rotatably couple to the proximal portion 535 at a second joint 574. As discussed above, the securement arms can be arranged to contact the head of a user at least at two or more contact locations. The first contact location can be represented by a first contact feature or touch pad 585. The second contact location can be represented by a second contact feature or touch pad 585.

As shown in FIG. 5, the portions of the securement arm 530 can be rotated about the joints 572 or 574 to adjust or change contact distances. The contact distances can be the distance between the first portion 532 or the first joint 572 and the contact locations. The contact locations can be represented in FIG. 5 by the contact features 585, 587. In one example, the contact features 585, 587 can be touch pads. In the initial position, the first touch pad 585 can have an initial proximal contact distance 547. By rotating the proximal portion 535 outward or inward about the first joint 572, the first contact distance can be changed or decreased to a secondary proximal contact distance 549. Similarly, in an initial configuration, the second contact feature 587 can have an initial distal contact distance 565 defined between the second touch pad 587 and the first joint 572. By adjustably rotating the distal portion 550 about the second joint 574, the distal contact distance 564 can be changed (e.g. increased or decreased). For example, the distal contact distance 564 can be changed or increased to a secondary distal contact distance 565. In another example, both the proximal portion 535 and the distal portion 550 can be rotated to define a tertiary distal contact distance 566. Accordingly, various contact distances for each contact feature 585, 587 or contact location can be defined by adjusting the position or orientation of the securement arm 530.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

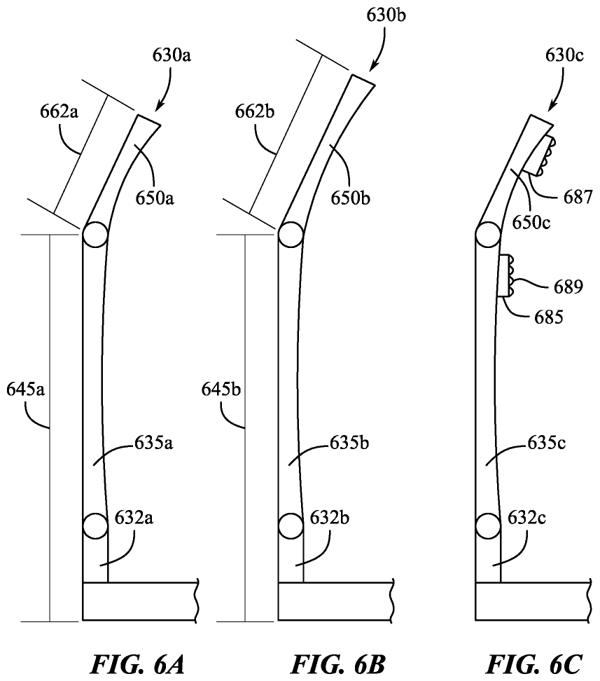

FIG. 6A, FIG. 6B, and FIG. 6C illustrate top views of example configurations of the securement arm. For example, FIG. 6A shows a first example configuration of the securement arm 630a. FIG. 6B shows a second example configuration of the securement arm 630b. FIG. 6C shows a second example configuration of the securement arm 630c.

The first example configuration of the securement arm 630a can include a first portion 632a, a proximal portion 635a, and a distal portion 650a. The proximal portion 635a can have a proximal length 645a. The distal portion 650a can have a distal length 662a. Generally, the proximal length 645a can be greater than the distal length 662a for the various configurations of securement arms. For example, the distal length 662a can be less than 50% of the length of the proximal length 645a.

The second example configuration of the securement arm 630b can include a first portion 632b, a proximal portion 635b, and a distal portion 650b. The proximal portion 635b can have a proximal length 645b. The distal portion 650b can have a distal length 662b. The second example configuration can be arranged to have a distal portion 650b with a distal length 662b greater than the distal length 662a of the first configuration. In some examples, the distal length 662b can be between 50% and 100% of the length of the proximal length 662b. The longer distal portion 662b can disperse the weight of the optical device over a larger area, accommodate larger or longer heads, or provide increased securement for more active uses of the optical device.

The third example configuration of the securement arm 630c can include a first portion 632c, a proximal portion 635c, and a distal portion 650c. The third configuration 630c can include contact features or touch pads, such as a first touch pad 685 on the proximal portion 635c or a second touch pad 687 on the distal portion 650c, to increase the coefficient of friction at the contact locations. In some examples, one or both of the touch pads 685, 687 can include surface features 689. The surface features 689 can be ridges, grooves, teeth, combs, or to further increase the coefficient of friction of the securement arms 630c or otherwise assist in securing the securement arms 630c to the head of a user.

Any of the features, components, and/or parts, including the arrangements and configurations thereof shown in FIG. 6A, FIG. 6B, or FIG. 6C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, cither alone or in any combination, in the example of the devices, features, components, and parts shown in FIG. 6A, FIG. 6B, or FIG. 6C.

To the extent applicable to the present technology, gathering and use of data available from various sources can be used to improve the delivery to users of invitational content or any other content that can be of interest to them. The present disclosure contemplates that in some instances, this gathered data can include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data can be used to provide insights into a user's general wellness, or can be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A head mountable device, comprising:
a frame;
a window connected to the frame; and
a securement arm extending from the frame, the securement arm comprising:
a proximal segment including a first contact feature;
a distal segment including a second contact feature, the proximal segment disposed between the distal segment and the frame; and
a joint, the distal segment rotatably coupled to the proximal segment at the joint; wherein:
an interior side of the securement arm defines a interior radius of curvature; and
an exterior side of the securement arm opposite the interior side defines an exterior radius of curvature, the exterior radius of curvature being greater than the interior radius of curvature.

2. The head mountable device of claim 1, wherein:
the proximal segment includes a first proximal end secured to the display frame and a first distal end opposite the first proximal end; and
the first contact feature is located at or near the first distal end.

3. The head mountable device of claim 1, wherein:
the distal segment includes a second proximal end secured to the proximal segment at the joint and a second distal end opposite the second proximal end; and
the second contact feature is located at or near the second distal end.

4. The head mountable device of claim 1, wherein:
the proximal segment defines a proximal interior radius of curvature;
the distal segment defines a distal interior radius of curvature; and
the proximal interior radius of curvature is greater than the distal interior radius of curvature.

5. The head mountable device of claim 1, wherein the second contact feature is oriented towards the display frame.

6. The head mountable device of claim 5, wherein the distal segment is rotatable about the joint to adjust an angle of the second contact feature relative to the display frame.

7. A securement arm for a wearable device, comprising:
a first portion defining a volume;
an electronic component disposed within the volume;
a proximal portion having a first proximal end rotatably coupled to the first portion and a first distal end opposite the first proximal end, the proximal portion defining a first contact location at or near the first distal end; and
a distal portion having a second proximal end rotatably coupled to the proximal portion and a second distal end opposite the second proximal end, the distal portion defining a distal contact location at or near the second distal end;
wherein the proximal portion defines an interior side having a concave radius of curvature.

8. The securement arm of claim 7, wherein:
the distal portion defines a distal interior side; and
the distal interior side has a distal radius of curvature aligning with the concave radius of curvature.

9. The securement arm of claim 7, wherein:
a proximal contact distance is defined between the first contact location and the first portion; and
rotating the proximal portion relative to the first portion causes the proximal contact distance to change.

10. The securement arm of claim 7, wherein:
a distal contact distance is defined between the distal contact location and the first portion; and
rotating the distal portion relative to the proximal portion causes the distal contact distance to change.

11. The securement arm of claim 10, wherein rotating the proximal portion relative to the first portion causes the distal contact distance to change.

12. The securement arm of claim 7, wherein the portion is configured to rotate outward and inward relative to the first proximal portion.

13. The securement arm of claim 7, wherein:
the electronic component includes a projector disposed in the first portion; and
the first portion is fixed in position.

14. The securement arm of claim 7, wherein:
the proximal portion has a first length;
the distal portion has a second length; and
the first length is greater than the second length.

15. An electronic device, comprising:
a frame;
a window secured to the frame;
a securement arm coupled to the frame, the securement arm comprising:
a fixed portion connected to the frame and including a projector configured to project light that is displayed at the window;
a first portion coupled to the fixed portion and including a first touch pad at a first contact location;
a second portion including a second touch pad at a second contact location; and
a joint rotatably coupling the first portion and the second portion, the joint located between the first touch pad and the second touch pad.

16. The electronic device of claim 15, wherein:
the securement arm defines an interior side oriented toward the frame; and
the first touch pad and the second touch pad extend from the interior side.

17. The electronic device of claim 15, wherein:
the first touch pad comprise a first material; and
the first portion comprises a second material different than the first material.

18. The electronic device of claim 17, wherein the first material has a greater coefficient of friction than the second material.

19. The electronic device of claim 15, wherein the second touch pad includes surface features configured to increase a friction of the second touch pad against a user when the user dons the electronic optical device.

20. The electronic device of claim 15, wherein:
the first contact location is adjacent the joint; and
the second contact location is at or near a distal end of the second portion and spaced further from the joint than the first contact location.
